(19) United States
(12) Patent Application Publication
(10) Pub. No.: US 2026/0121349 A1
(43) Pub. Date: Apr. 30, 2026

(54) Self-Aligning Electrial Connector

(71) Applicant: TE Connectivity Solutions GmbH, Schaffhausen (CH)

(72) Inventors: Brian Keith WEAVER, Middletown, PA (US); Matthew Edward MOSTOLLER, Middletown, PA (US)

(73) Assignee: TE Connectivity Solutions GmbH, Schaffhausen (CH)

(21) Appl. No.: 18/931,303

(22) Filed: Oct. 30, 2024

(51) Int. Cl. H01R 13/64; H01R 13/631

(52) U.S. Cl. CPC H01R 13/64; H01R 13/631

(57) ABSTRACT

An electrical connector assembly having a housing with a mating connector receiving portion and a panel mounting portion. The mating connector receiving portion has side walls and end walls. The mating connector receiving portion extends from the panel mounting portion. The panel mounting portion has an oversized flange with a panel mounting surface. The panel mounting surface has a width which is greater than a width of the mating connector receiving portion and a length which is greater than the length of the mating connector receiving portion. First springs and second springs are provided about the periphery of the mating connector receiving portion. The first springs and second springs have panel engagement portions and securing portions. The electrical connector assembly is configured to float relative to the panel and to compensate for misalignment of a mating electrical connector.

### BACKGROUND OF THE INVENTION

The invention relates generally to a self-aligning electrical connector. In particular, the invention relates to self-aligning connector which can comply as needed in the X and Y directions and which can comply if a torsional mating misalignment occurs.

Connectors of conventional electrical connector assemblies can often be difficult to properly mate without several attempts. That is particularly true as connectors are often situated or located such that one or more of the connectors is not easily visible or as connectors get smaller in size, thereby making them more difficult to see and manipulate. If the connectors are misaligned, the connectors may be prevented from being assembled, or if assembled, unwanted stresses may be applied to the housing and the contacts of the connectors, resulting in failure of the electrical connection and the system.

In various known systems, one or both of the connectors may be configured to allow for the center axis of the connector to shift or move to correct for misalignment. However, the connectors allow for the movement in one or more of the X, Y or Z directions. There is no ability to compensate for torsional misalignment.

Therefore, a need exists for an electrical connector assembly in which at least one electrical connector allows for movement to compensate for X, Y and torsional misalignment, to facilitate proper mating of the connectors, particularly when blind-mating the components or when the components are small and difficult to manipulate.

### SUMMARY OF THE INVENTION

A connector housing has an oversized outer flange with integrated springs, such as leaf springs, a cover plate, and a specific panel cutout design. The panel is captured between the oversized flange of the connector housing and the cover plate. The leaf springs are pre-assembled and captured by features on the oversized flange of the connector housing. When fully assembled the leaf spring elements along the periphery of the flange put an outward force on the protruding features of the panel cutout (see attached presentation). The leaf spring elements allow the connector assembly to comply as needed in the X and Y directions. They will also allow the connector assembly to comply if a torsional mating mis-alignment occurs.

The self-alignment feature as described herein allows for a reduced footprint and thickness of the connector assembly. In addition, the connector assembly can be used in various systems, including battery connection systems where there are applications with high mating cycle requirements and customers want the connection to be as simple and error proof as possible for the end user.

An embodiment is directed to an electrical connector assembly having a housing with a mating connector receiving portion and a panel mounting portion. The mating connector receiving portion has side walls and end walls. The mating connector receiving portion extends from the panel mounting portion. The panel mounting portion has an oversized flange with a panel mounting surface. The panel mounting surface has a width which is greater than a width of the mating connector receiving portion and a length which is greater than the length of the mating connector receiving portion. First springs and second springs are provided about the periphery of the mating connector receiving portion. The first springs and second springs have panel engagement portions and securing portions. With the electrical connector assembly mounted in an opening of a panel, the panel engagement portions of the first springs and the second springs cooperate with projections of the panel which extend into the opening to allow the electrical connector assembly to float relative to the panel and to compensate for misalignment of a mating electrical connector in the X direction, misalignment of the mating electrical connector in the Y direction and/or for torsional misalignment of the mating electrical connector.

An embodiment is directed to an electrical connector system having an electrical connector assembly and a panel. The electrical connector assembly includes a housing with a mating connector receiving portion and a panel mounting portion. The mating connector receiving portion has side walls and end walls. The mating connector receiving portion extends from the panel mounting portion. The panel mounting portion has an oversized flange with a panel mounting surface. The panel mounting surface has a width which is greater than a width of the mating connector receiving portion and a length which is greater than the length of the mating connector receiving portion. First springs and second springs are provided about the periphery of the mating connector receiving portion. The first springs and second springs have panel engagement portions and securing portions. The panel has a connector receiving opening dimensioned to receive the mating connector receiving portion therethrough. Projections extend into the connector receiving opening. The projections align with the panel engagement portions of the first springs and second springs. The panel engagement portions of the first springs and the second springs cooperate with the projections of the panel to allow the electrical connector assembly to float relative to the panel and to compensate for misalignment of a mating electrical connector in the X direction, misalignment of the mating electrical connector in the Y direction and/or for torsional misalignment of the mating electrical connector.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a front perspective view of an illustrative connector assembly mounted to a panel and an illustrative mating connector assembly shown prior to the connector assembly and the mating connector assembly being mated to form and electrical connection therebetween.

FIG. 2 is a back perspective of the connector assembly and the mating connector assembly of FIG. 1.

FIG. 3 is a front perspective view of the illustrative connector assembly and the mating connector assembly of FIG. 1 shown in the mated position.

FIG. 4 is an exploded perspective view of the connector assembly of FIG. 1.

FIG. 5 is a front view of the connector assembly of FIG. 4 with a cover of the connector assembly removed.

FIG. 6 is a perspective view of an illustrative first leaf spring of the connector assembly.

FIG. 7 is a perspective view of an illustrative second leaf spring of the connector assembly.

FIG. 8 is a cross-section view of the connector assembly taken along line 8-8 of FIG. 5.

FIG. 9 is a front view of the mating connector assembly of FIG. 1.

FIG. 10 is a front view of the panel prior to the connector assembly being mounted thereto.

FIG. 11 is a front view of the panel with the connector assembly mounted thereto, the cover of connector assembly has been removed.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

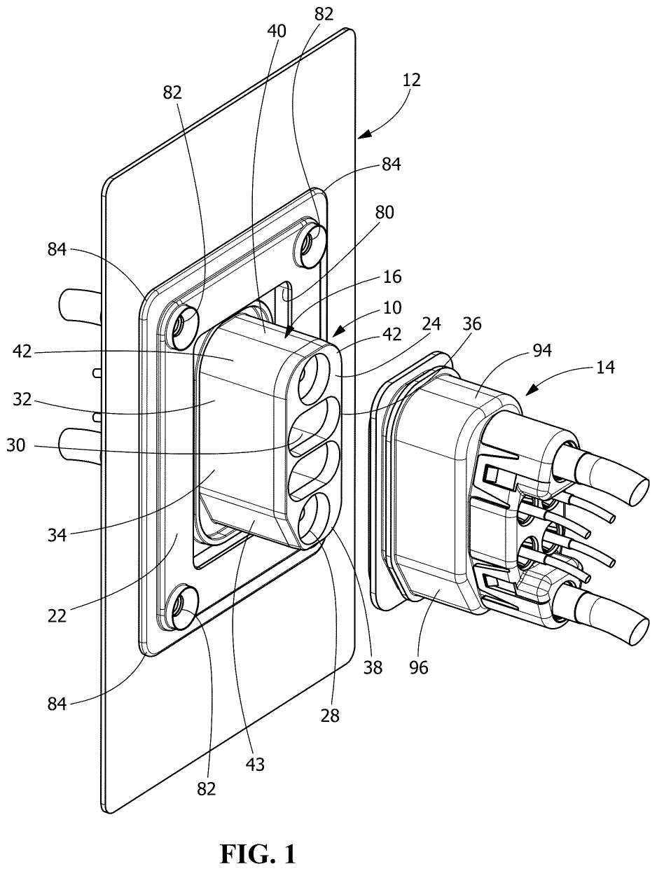

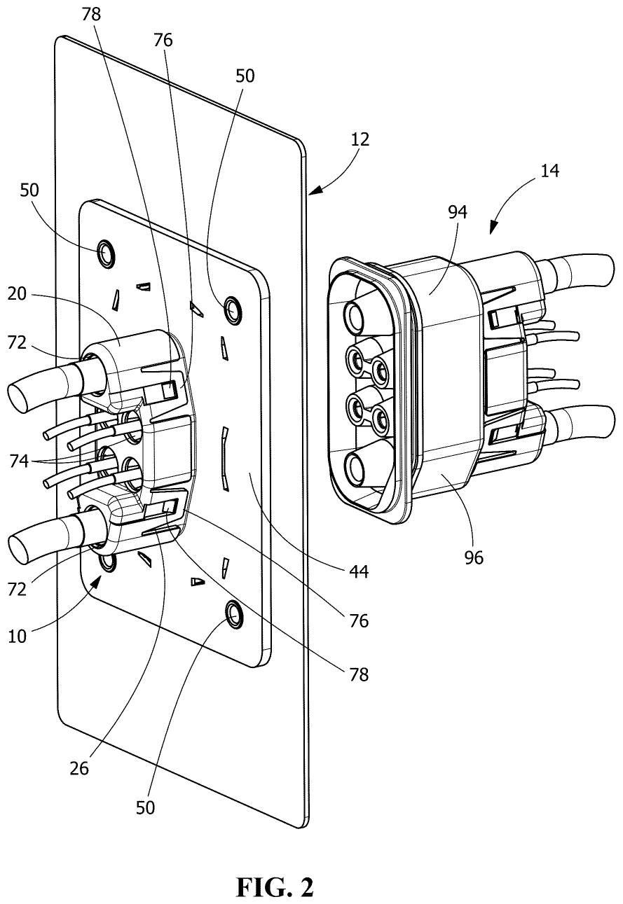

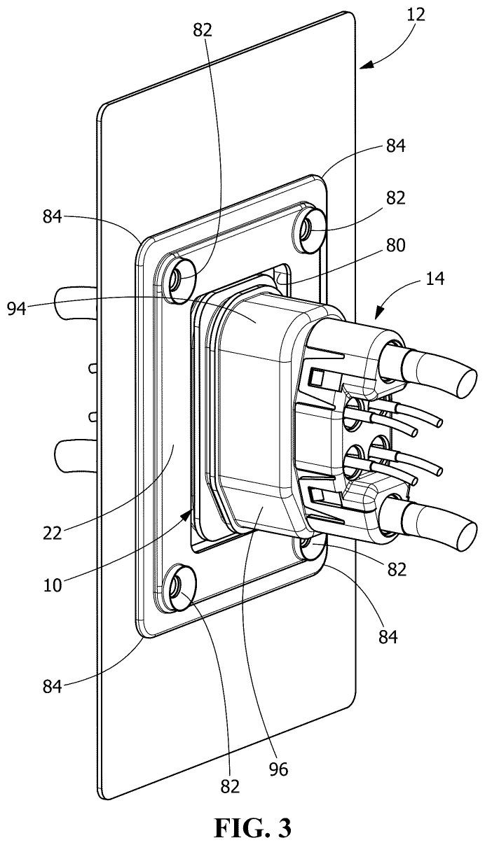

As shown in FIGS. 1 through 3, an illustrative first electrical connector assembly 10 is mounted to a panel 12 to form an electrical connector system. A second or mating electrical connector assembly 14 is configured to mate with the first connector assembly 10, as shown in FIG. 3. In the illustrative embodiment the first connector assembly 10 and the mating connector assembly 14 are configured to transmit power when mated. However, in other embodiments, the first connector assembly 10 and the mating connector assembly 14 may be configured to accommodate signal transmissions.

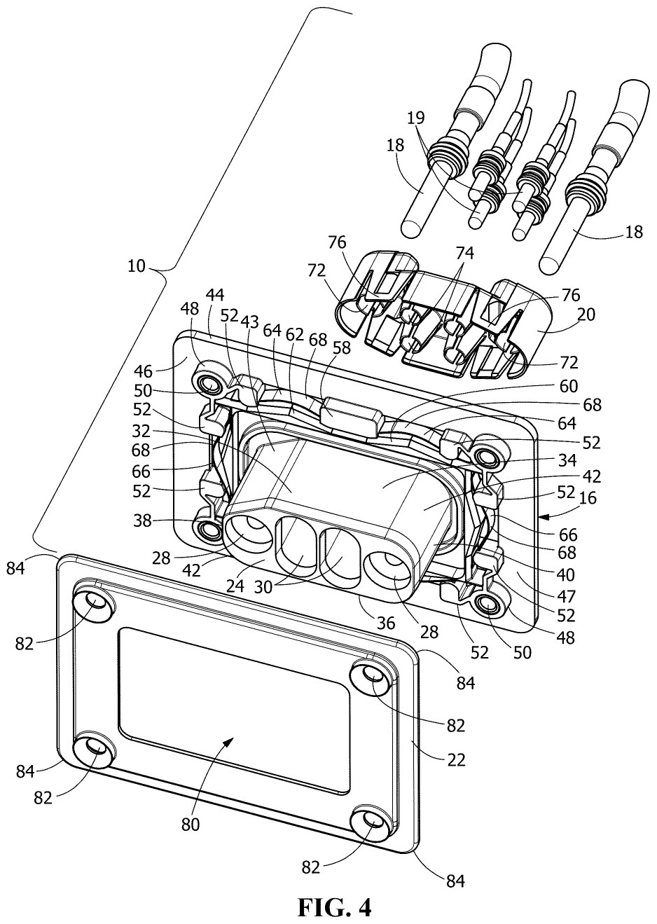

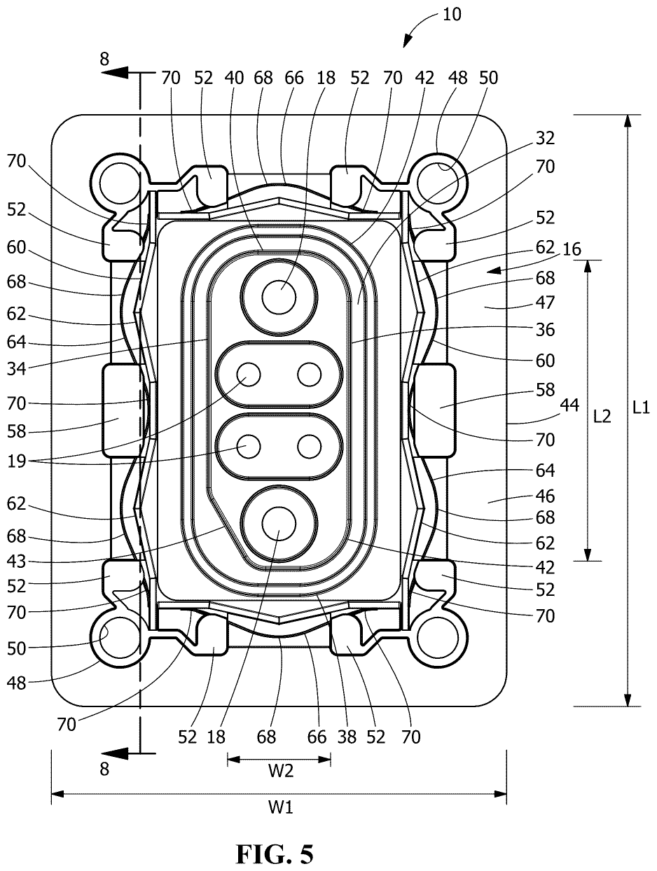

As shown in FIGS. 4 and 5, the first connector assembly 14 has a housing 16, terminals or contacts 18, 19, a contact retention member 20, and a cover 22. In the illustrative embodiment shown, the housing 16 and the contact retention member 20 are separate pieces which are mated together, but other configurations may be used.

The housing 16 has a mating connector receiving surface 24 and an oppositely facing terminal receiving surface 26. Terminal receiving cavities 28, 30 extend from the mating connector receiving surface 24 to the terminal receiving surface 26.

A mating connector receiving portion 32 extends from the mating connector receiving surface 24 toward the terminal receiving surface 26. In the illustrative embodiment shown, the mating connector receiving portion 32 has a generally rectangular configuration with opposing side walls 34, 36 and opposing end walls 38, 40. The corners 42 provided between the side walls 34, 36 and end walls 38, 40 have an arcuate configuration. In one corner, an angled surface 43 extends between the side wall 34 and the end wall 38. However, the configuration of the mating connector receiving portion 32 may vary.

A panel mounting portion 44 with a panel mounting surface 46 of an oversized outer flange 47 is provided between the mating connector receiving surface 24 and the oppositely facing terminal receiving surface 26. The panel mounting surface 44 is positioned adjacent to the mating connector receiving portion 32. The panel mounting surface 44 has a width W1 which is greater than the width W2 of the mating connector receiving portion 32 and a length L1 which is greater than the length L2 of the mating connector receiving portion 32. Consequently, the flange 47 and the panel mounting surface 46 extend beyond the side walls 34, 36 and end walls 38, 40 as viewed in FIGS. 4 and 5.

As shown in FIGS. 4 and 5, mounting projections 48 extend outward from the panel mounting surface 46. In the illustrative embodiment shown, the mounting projections 48 are provided proximate, but spaced from, the corners 42 of the mating connector receiving portion 32. Mounting openings 50 extend through the mounting projections 48.

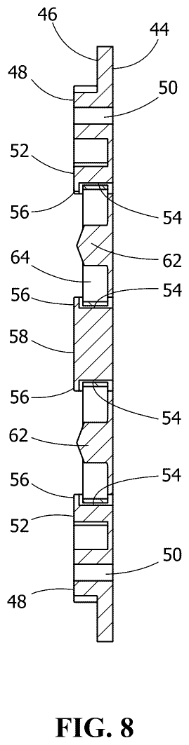

Spring retention projections 52 extend outward from the panel mounting surface 46 in the same direction as the mounting projections 48. In the illustrative embodiment shown, two spring retention projections 52 are provided proximate each mounting projection 48. The two spring retention projections 52 are positioned at essentially right angles to each other. As shown in FIG. 8, the spring retention projections 52 have recessed portion 54 with retaining shoulders 56 which are spaced from the panel mounting surface 46. The retaining shoulders 56 extend in a direction which is essentially parallel to the panel mounting surface 46.

Additional spring retention projections 58 extend outward from the panel mounting surface 46 in the same direction as the mounting projections 48, as shown in FIGS. 4 and 5. In the illustrative embodiment shown, two spring retention projections 58 are provided between respective corners 42 on opposite sides of the panel mounting portion 44 and between respective spring retention projections 52. As shown in FIG. 8, the spring retention projections 58 also have recessed portion 54 with retaining shoulders 56 which are spaced from the panel mounting surface 46. The retaining shoulders 56 extend in a direction which is essentially parallel to the panel mounting surface 46.

Overstress walls or projections 60 extend outward from the panel mounting surface 46 in the same direction as the mounting projections 48. The overstress projections 60 extend about the periphery of the mating connector receiving portion 32. In the illustrative embodiment shown, the overstress projections 60 have spring engagement portions 62 which are positioned between respective spring retention projections 52, 58.

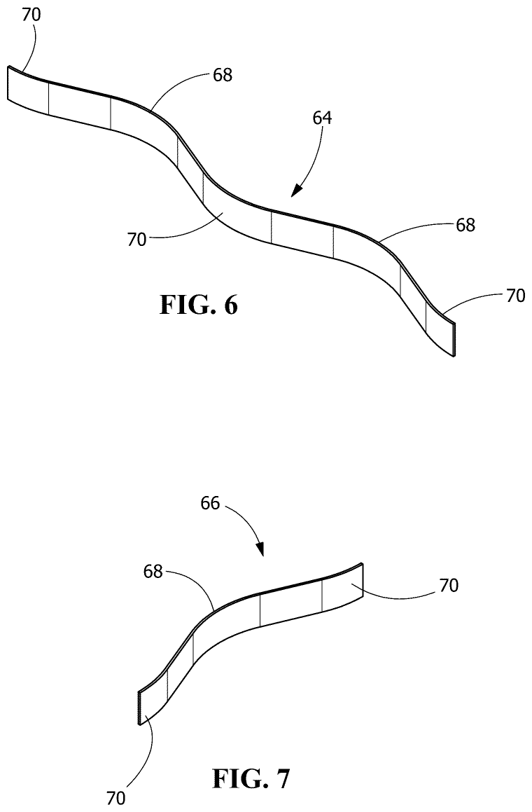

Resilient members or springs 64, 66 are provided about the periphery of the mating connector receiving portion 32. In the illustrative embodiment the springs 64, 66 are leaf springs as shown in FIGS. 6 and 7.

As shown in FIGS. 5 and 6, springs 64 are dimensioned to extend in a direction which is essentially parallel to opposing side walls 34, 36. In the illustrative embodiment, each spring 64 has two panel engagement portions 68 and three securing portions 70. The securing portions 70 are positioned in the recessed portions 54 of the spring retention projections 52 and the spring retention projections 58. The retaining shoulders 56 cooperate with the securing portions 70 to movably retain the leaf springs 64 in position proximate the panel mounting surface 46 of the panel mounting portion 44. The overstress projections 60 are positioned proximate to, but spaced from the spring retention projections 52 and the spring retention projections 58 to allow the springs 64 to be resiliently deformed while being maintained in position on the panel mounting surface 46 of the panel mounting portion 44. The overstress projections 60 are configured to prevent the overstress of the springs 64.

As shown in FIGS. 5 and 7, springs 66 are dimensioned to extend in a direction which is essentially parallel to opposing side walls 38, 40. In the illustrative embodiment, each spring 66 has one panel engagement portions 68 and two securing portions 70. The securing portions 70 are positioned in the recessed portions 54 of the spring retention projections 52. The retaining shoulders 56 cooperate with the securing portions 70 to movably retain the leaf springs 66 in position proximate the panel mounting surface 46 of the panel mounting portion 44. The overstress projections 60 are positioned proximate to, but spaced from the spring retention projections 52 to allow the springs 64 to be resiliently deformed while being maintained in position on the panel mounting surface 46 of the panel mounting portion 44. The overstress projections 60 are configured to prevent the overstress of the springs 66.

The terminals or contacts 18 are positioned in the terminal receiving cavities 28, and terminals or contacts 19 are positioned in the terminal receiving cavities 30 of the housing 16. In the illustrative embodiment shown, the contacts 18 are power contacts and the contacts 19 are signal contacts. However other configurations of the contacts may be used.

The contact retention member 20 is secured to the housing 16 and extends from the terminal receiving surface 26 in a direction away from the mating connector receiving surface 24. The contact retention member 20 has contact receiving openings 72, 74 for receiving and maintaining respective terminals 18, 19 therein. Resilient latch arms 76 are provided on the contact retention member 20. The resilient latch arms 76 cooperate with latching projections 78 on the housing 16 to retain the contact retention member 20 on the housing 16, thereby facilitating the retention of the contacts 18, 19 in the housing 16.

The cover 22 has a housing receiving opening 80 which is dimensioned to receive the mating connector receiving portion 32 of the housing 16 therein. In the illustrative embodiment shown, the cover 22 is essentially a planar member with mounting openings 82. In the illustrative embodiment shown, the mounting openings 82 are provided proximate, but spaced from, corners 84 of the cover 22. The mounting openings 82 aligned with the mounting openings 50 of the mounting projections 48 when the cover 22 is assembled to the housing 16. When fully assembled, the panel 12 is positioned and retained between the panel mounting surface 46 of the panel mounting portion 44 of the housing 16 and the cover 22. In the fully assembled position, the cover 22 helps to retain the springs 64, 66 is position relative to the panel mounting surface 46 of the connector assembly 10 and relative to the panel 12.

The panel 12, as shown in FIG. 10, has a connector receiving opening 88 which is dimensioned to receive the mating connector receiving portion 32 of the housing 16 therethrough. Projections 90 extend into the connector receiving opening 88 from side walls of the opening 88. The projections 90 are configured to align with the panel engagement portions 68 of the resilient members or springs 64, 66, as shown in FIG. 10. Mounting openings 92 are provided at the corners of the connector receiving opening 88. The mounting openings 92 are configured to allow any mounting hardware which extends through mounting openings 82 of the cover 22 to the mounting openings 50 of the mounting projections 48 of the pane mounting portion 44 of the connector assembly 10 to move relative to the panel 12.

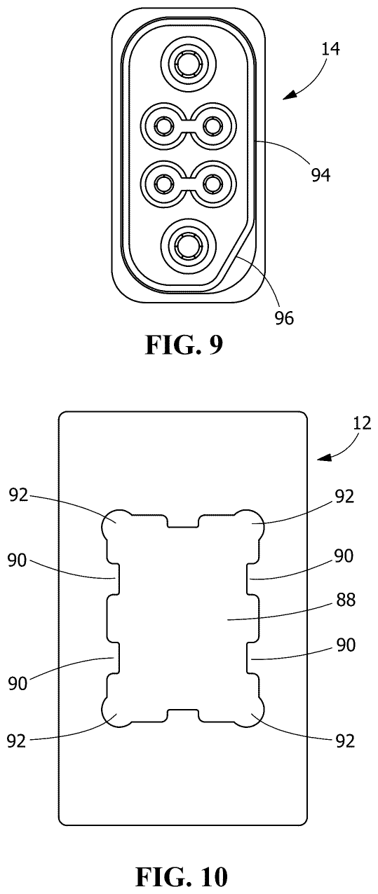

The mating connector assembly 14, as shown in FIG. 9, has a mating portion 94 which is configured to engage the mating connector receiving portion 32. In the illustrative embodiment shown, the mating portion 94 has an angled surface 96 in one corner. The angled surface 96 cooperates with the angled surface 43 of the mating connector receiving portion 32 of the connector assembly 12 to provided a keying mechanism to ensure that the mating connector assembly 14 and the connector assembly 14 can only be mated in the proper orientation, as shown in FIG. 3.

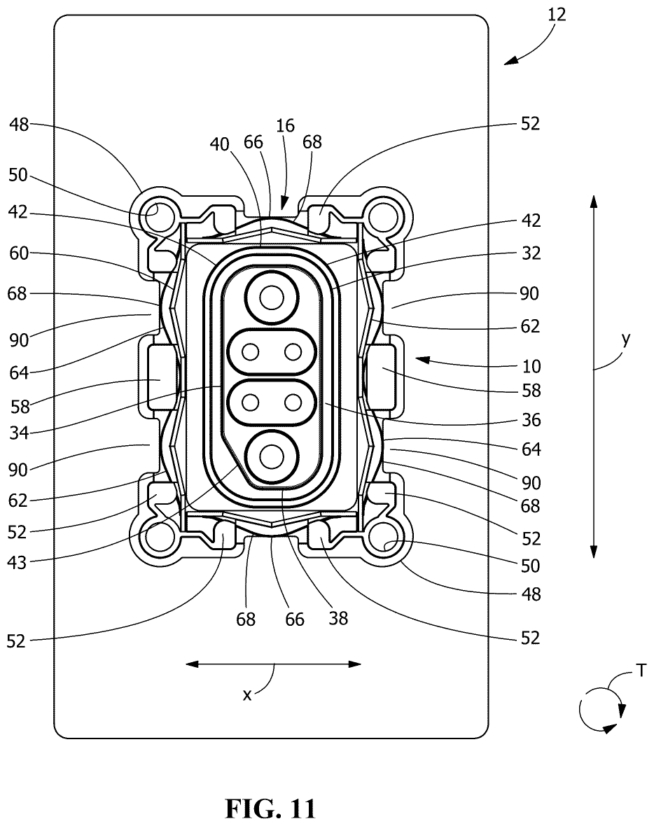

As shown in FIG. 11, when properly mounted to the panel 12, the resilient members or springs 64, 66 are configured to engage the projections 90 of the panel 12 to allow the connector assembly 10 to float relative to the panel 12. This allows the electrical connector assembly 10 to compensate for misalignment of the mating electrical connector 14 in the X direction (as represented by arrow x in FIG. 11), the Y direction (as represented by arrow y in FIG. 11) and/or for torsional misalignment (as represented by arrow T in FIG. 11).

In the embodiment shown, the resilient members or springs 64, 66 are leaf springs which are compressible to allow the housing 16 of the electrical connector assembly 10 to move relative to the panel 12 to change a position of the mating connector receiving portion 32 of the connector assembly 10 relative to the panel 10 for mating with the mating connector assembly 14.

In the initial position, as shown in FIGS. 1, 2 and 10, the resilient members or springs 64, 66 bias the connector assembly 10 and the mating connector receiving portion 32 to a resting position relative to the panel 12 by applying an outward force on the projections 90 of the panel connector receiving opening or cutout 88. The resilient members or springs 64, 66 For example, the mating connector receiving portion 32 may be approximately centered within the connector receiving opening 88 of the panel 12 in the resting position. The mating connector receiving portion 32 of the connector assembly 10 is movable from the resting position to an offset position (for example, movable in the X direction, Y direction or rotational), to align the connector assembly 10 with the mating connector assembly 14 when the mating connector assembly 14 engages the connector assembly 10. The resilient members or springs 64, 66 may be compressed when the connector assembly 10 moves to the offset position. The resilient members or springs 64, 66 return the connector assembly 10 from the offset position to the resting position when the connector assembly 10 is released.

The compression and expansion of the springs 66 allow the mating connector receiving portion 32 of the connector assembly 10 to move in the X direction to accommodate misalignment of the mating connector assembly 14 in the X direction as the mating connector assembly 14 is mated to the connector assembly 10. The compression and expansion of the springs 64 allow the mating connector receiving portion 32 of the connector assembly 10 to move in the Y direction to accommodate misalignment of the mating connector assembly 14 in the Y direction as the mating connector assembly 14 is mated to the connector assembly 10.

With respect to torsional or rotation misalignment, various portions of the springs 64, 66 are compressed or expanded to allow the mating connector receiving portion 32 of the connector assembly 10 to move or rotated in the X direction and the Y direction to accommodate for torsional or rotational misalignment of the mating connector assembly 14 as the mating connector assembly 14 is mated to the connector assembly 10.

As the springs 64, 66 are movably mounted in the recessed portions 54 by the retaining shoulders 56, the springs 64, 66, and the free ends of the springs 64, 66 are slidable with in the recessed portions. This allows the panel engagement portions 68 of the springs 64, 66 to be moved toward the spring engagement portions 62 of the overstress projections 60 as the panel engagement portions 68 engage the projections 90 of the panel 12 as the mating connector receiving portion 32 is moved by the mating connector 14. The positioning of the spring engagement portions 62 of the overstress projections 60 prevents the excess movement or over deflection of the springs 64, 66, thereby limiting limit over deflection of the springs 64, 66 to prevent the springs 64, 66 from taking a permanent set.

During the mating of the mating connector assembly 14 to the connector assembly 10, the mating portion 94 of the mating connector assembly 14 engages the mating connector receiving portion 32 of connector assembly 10. If the mating connector assembly 14 is not properly aligned, the mating portion 94 of the mating connector assembly 14 will cause the mating connector receiving portion 32 of connector assembly 10 to move relative to the panel 12. As this occurs, respective springs 64, 66 will engage the projection 90 of the panel 12, causing the respective springs 64, 66 to compress.

The springs 64, 66 control the horizontal positioning of the connector assembly 10 relative to the panel 12. The size and shape of the springs 64, 66 may be varied to control the amount of horizontal offset or float allowed by the connector assembly 10 within the connector receiving opening 88 of the panel.

When fully assembled, the resilient members or springs 64, 66 on the panel mounting portion along the periphery of the flange 47 of the panel mounting portion 44 of the connector assembly 10 put an outward force on the projections 90 of the panel connector receiving opening or cutout 88. The resilient members or springs 64, 66 allow the connector assembly 10 to comply as needed in the X and Y directions when mated with the mating connector assembly 14. They will also allow the connector assembly 10 to comply if a torsional mating mis-alignment occurs with the mating connector assembly 14.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An electrical connector assembly comprising:
a housing comprising:
a mating connector receiving portion having side walls and end walls;
a panel mounting portion, the mating connector receiving portion extending from the panel mounting portion, the panel mounting portion having an oversized flange with a panel mounting surface, the panel mounting surface having a width which is greater than a width of the mating connector receiving portion and a length which is greater than the length of the mating connector receiving portion;
first springs and second springs being provided about the periphery of the mating connector receiving portion, the first springs and second springs having panel engagement portions and securing portions;
wherein upon the electrical connector assembly being mounted in an opening of a panel, the panel engagement portions of the first springs and the second springs cooperate with projections of the panel which extend into the opening, such that the electrical connector assembly floats relative to the panel and compensates for misalignment of a mating electrical connector in the X direction, misalignment of the mating electrical connector in the Y direction and/or for torsional misalignment of the mating electrical connector.

2. The electrical connector assembly as recited in claim 1, wherein the first springs extend in a direction which is essentially parallel to the side walls of the mating connector receiving portion and the second springs extend in a direction which is essentially parallel to the end walls of the mating connector receiving portion.

3. The electrical connector assembly as recited in claim 2, wherein each first spring of the first springs has two panel engagement portions and three securing portions and each second spring of the second springs has one panel engagement portions and two securing portions.

4. The electrical connector assembly as recited in claim 1, wherein the securing portions are positioned in recessed portions of spring retention projections which extend from the panel mounting surface of the panel mounting portion, retaining shoulders cooperate with the securing portions to movably retain the first spring and the second springs in position proximate the panel mounting surface of the panel mounting portion.

5. The electrical connector assembly as recited in claim 4, wherein overstress projections are positioned proximate to, but spaced from the spring retention projections to allow the first springs and second springs to be resiliently deformed while being maintained in position on the panel mounting surface of the panel mounting portion and to prevent the overstress of the first springs and the second springs.

6. The electrical connector assembly as recited in claim 1, wherein the housing has a mating connector receiving surface and an oppositely facing terminal receiving surface, terminal receiving cavities extend from the mating connector receiving surface to the terminal receiving surface, terminals are positioned in the terminal receiving cavities, the panel mounting portion is positioned between the mating connector receiving surface and the terminal receiving surface.

7. The electrical connector assembly as recited in claim 1, wherein a respective side wall of the side walls of the mating connector receiving portion has an angled surface.

8. The electrical connector assembly as recited in claim 1, wherein mounting projections extend outward from the panel mounting surface, the mounting projections are provided proximate, but spaced from, corners of the mating connector receiving portion, mounting openings extend through the mounting projections.

9. The electrical connector assembly as recited in claim 8, wherein first spring retention projections extend outward from the panel mounting surface in the same direction as the mounting projections.

10. The electrical connector assembly as recited in claim 9, wherein two first spring retention projections are provided proximate each mounting projection, the two first spring retention projections are positioned at essentially right angles to each other, the first spring retention projections have recessed portion with retaining shoulders which are spaced from the panel mounting surface, the retaining shoulders extend in a direction which is essentially parallel to the panel mounting surface.

11. The electrical connector assembly as recited in claim 10, wherein second spring retention projections extend outward from the panel mounting surface in the same direction as the mounting projections.

12. The electrical connector assembly as recited in claim 11, wherein the second spring retention projections are provided between respective first spring retention projections, the second spring retention projections have recessed portion with retaining shoulders which are spaced from the panel mounting surface, the retaining shoulders extend in a direction which is essentially parallel to the panel mounting surface.

13. The electrical connector assembly as recited in claim 1, wherein overstress projections extend outward from the panel mounting surface, the overstress projections extend about the periphery of the mating connector receiving portion.

14. The electrical connector assembly as recited in claim 13, wherein the overstress projections have spring engagement portions which are positioned between respective spring retention projections of the overstress projections.

15. The electrical connector assembly as recited in claim 1, wherein the first springs and the second springs are leaf springs.

16. The electrical connector assembly as recited in claim 6, wherein a contact retention member is secured to the housing and extends from the terminal receiving surface in a direction away from the mating connector receiving surface, the contact retention member has contact receiving openings for receiving and maintaining respective terminals therein, resilient latch arms are provided on the contact retention member, the resilient latch arms cooperate with latching projections on the housing to retain the contact retention member on the housing.

17. The electrical connector assembly as recited in claim 1, wherein the electrical connector assembly has a cover with a housing receiving opening which is dimensioned to receive the mating connector receiving portion of the housing therein, when assembled the panel is positioned and retained between the panel mounting surface of the panel mounting portion of the housing and the cover, the cover retains the first springs and the second springs in position relative to the panel mounting surface of the connector assembly and relative to the panel.

18. An electrical connector system comprising:
an electrical connector assembly comprising:
a housing comprising:
a mating connector receiving portion having side walls and end walls;
a panel mounting portion, the mating connector receiving portion extending from the panel mounting portion, the panel mounting portion having an oversized flange with a panel mounting surface, the panel mounting surface having a width which is greater than a width of the mating connector receiving portion and a length which is greater than the length of the mating connector receiving portion;
first springs and second springs are provided about the periphery of the mating connector receiving portion, the first springs and second springs having panel engagement portions and securing portions;
a panel having a connector receiving opening dimensioned to receive the mating connector receiving portion therethrough, projections extending into the connector receiving opening, the projections align with the panel engagement portions of the first springs and second springs;
wherein the panel engagement portions of the first springs and the second springs cooperate with the projections of the panel, such that the electrical connector assembly floats relative to the panel and compensates for misalignment of a mating electrical connector in the X direction, misalignment of the mating electrical connector in the Y direction and/or for torsional misalignment of the mating electrical connector.

19. The electrical connector system as recited in claim 18, wherein the securing portions are positioned in recessed portions of spring retention projections which extend from the panel mounting surface of the panel mounting portion, retaining shoulders cooperate with the securing portions to movably retain the first spring and the second springs in position proximate the panel mounting surface of the panel mounting portion.

20. The electrical connector system as recited in claim 19, wherein overstress projections are positioned proximate to, but spaced from the spring retention projections to allow the first springs and second springs to be resiliently deformed while being maintained in position on the panel mounting surface of the panel mounting portion and to prevent the overstress of the first springs and the second springs.
